(19) United States
(12) Patent Application Publication
(10) Pub. No.: US 2003/0074273 A1
(43) Pub. Date: Apr. 17, 2003

(54) Apparatus and method for facilitating trade

(75) Inventors: Carl Anthony Miller, Birmingham (GB); Fraser Chrisfield Henderson, Dorridge (GB)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: Air Tube Group Limited

(21) Appl. No.: 10/138,044

(22) Filed: May 2, 2002

(30) Foreign Application Priority Data
Oct. 16, 2001 (GB) 01024758.4

(51) Int. Cl. G06F 17/60

(52) U.S. Cl. 705/26; 705/37

(57) ABSTRACT

An apparatus for facilitating transactions between a prospective purchaser and unrelated product or service suppliers is described. The apparatus comprises: a product or service database for storing product and/or service information for the suppliers; a supplier database for storing supplier contact information; a buyer's database for storing buyer contact information; and a product or service selection database into which products or services selected by the buyer are stored. A processor is provided for generating a purchase order pertaining to the selected products or services in response to a command from a purchaser. The processor splits the purchase order into separate orders of products or services pertaining to respective suppliers. These are then transmitted to the respective suppliers so that they can supply the buyer with the desired products or services.

This invention relates to an apparatus and method for facilitating trade, and in particular an apparatus and method which facilitates the buying of products and/or services from a plurality of product or service providers online via a single intermediary.

Trading exchanges which aim to foster trade between a buyer and one or more service providers or product suppliers have been proposed. Such systems have been proposed in order to provide for the obtaining of bulk purchasing advantages by aggregating demand. Previously proposed trading exchanges are essentially on-line market places designed to bring together buyers and suppliers providing the services to allow them to transfer information, goods and services between each other in a paperless environment. Typically, the Internet has been the medium used for providing the communication between the participants. There are four basic types of trading exchange, each developed to address a particular set of requirements or goals depending on the owners or originators. They are the Independent Vertical Exchange (IVX), Independent Horizontal Exchange (IHX), Private Trading Exchange (PTX), and Consortium Trading Exchange (CTX). An IVX is an independent platform developed to enable many buyers to transact with many suppliers. Its objective is to make a profit by providing facilities and value-added services to members. An IHX is similar to an IVX except that it operates in a horizontal manner, not aimed at any one specific market place. Many of the IHX's operate as auction sites while others like Mondus.co.uk utilise the “Request for Quote” (RFQ) approach. On Mondus, buyer members post an RFQ against which relevant suppliers quote. The buyer then reviews the quotes received and accepts or rejects. IHX's are also operated as potential profit making organisations. A CTX is a consortium of large companies from a particular vertical market whose aim in coming together is to influence efficiencies and cut costs in their supply chains. One of the ways that they achieve this is by group buying to take advantage of bulk purchase discounts. A PTX is owned and operated by a single company for the purpose of streamlining his business transactions with his trading partners. In this model the owner is involved in every transaction with many suppliers/customers.

A disadvantage with many of the early trading exchanges was that they are not developed to provide a trading platform as such but rather to provide information and services to either a particular vertical market or the public at large (B2C). In practice, potential buyers would log into a trading exchange site and view available products and services. The lack of any mechanism for providing for the ordering of goods and payment therefor in the business to business environment has the disadvantage that the trading exchanges are more for the provision of information than effecting trade. Once a prospective buyer has identified a product supplier or service provider, a direct person to person relationship is established and so the buyer is unlikely to refer again to the trading exchange for that particular product or service.

Some previously proposed on-line product or service procurement sites do provide for direct ordering of products or services together with direct payment. However, this is invariably in the business to personal customer environment (B2C) and the payment system is effected by way credit card. The difficulty with this is that many potential buyers do not like to divulge credit card information over the Internet and business-to-business transactions are unlikely to involve credit card payment methods at all. Consequently, there has been little or no growth in business to business (B2B) transactions via on-line trading exchanges.

Other difficulties arise in relation to business-to-business transactions over Internet trading exchanges. These arise over accreditation—a prospective buyer does not know the status or creditworthiness of a supplier and vice-versa. This has further tended to discourage on-line business-to-business transactions.

It is an aim of the present invention to provide an apparatus for facilitating trade transactions in goods and/or services which avoids the aforementioned disadvantages of the prior art.

It is a further aim of the present invention to facilitate the purchase of services and/or products from a plurality of different entity providers through a single ordering system.

It is another aim of the present invention to reduce the expenses and delays associated with financing trade.

A yet further aim of the present invention is to reduce the possibility of errors in documents pertaining to trade transactions and to reduce expenses associated with documents in prior art trade transactions.

It is a still further aim of the present invention to provide a computer based system and method for facilitating credit and status checks of the parties involved in a business to business transaction and for providing for payment for goods or services purchased via the system.

According to the present invention, there is provided a method of facilitating trade between a prospective buyer and a plurality of product or service suppliers comprising the steps of:

providing a prospective buyer with an option to select products or services for purchase from a plurality of different product and/or service suppliers;

generating a purchase order for said products and services in response to a command from the buyer to proceed with said purchase;

splitting said purchase order into a plurality of supplier orders whereby each supplier order contains products or services pertaining to a different supplier; and

notifying each supplier of the buyer's order in relation to the products or services pertaining to that supplier.

The method may include the step of holding the selection in a virtual shopping cart or basket and the step of notifying may include providing to each supplier the prospective buyer's shipping address.

The method, which may be performed by an intermediary or broker organisation, may include the step of generating an invoice in respect of each one of the supplier orders. The invoices may be transmitted to the buyer by the broker. The method may facilitate payment of each supplier by way of a funding organisation associated with or independent from the broker. In this case, the method includes the step of notifying the funding organisation of the funds to be paid to each supplier for the services or products pertaining to that supplier. The funding organisation, which may be a bank, transfers said funds to said supplier and debits said funds from a buyer. The transfer of said funds to said supplier may take place when the buyer confirms receipt of the services or products. Alternatively, the transfer of said funds may take place a first predetermined number of days after the supplier has dispatched the products or dispensed the services.

The buyer preferably has an account with the funding organisation in which funds are deposited. Alternatively or in addition, the buyer may have a credit facility with the funding organisation. In either case, the funding organisation may debit the funds from the buyer's account after a second predetermined number of days after dispatch of the products or services. Said second predetermined number of days may be longer than said first predetermined number of days depending on the commercial arrangement agreed between the parties. The funds provided to the supplier(s) may be less than the amount indicated to the buyer by an amount sufficient to cover a brokerage fee by the broker and/or service fee by said funding organisation. The funding organisation transfers the brokerage fee to the broker.

According to the present invention, there is also provided a computer executable software program stored on a computer readable medium which when run on a central computer provides a prospective buyer with an option to select products or services for purchase from a plurality of different product and/or service suppliers, said program comprising:

code responsive to a command from the buyer to proceed with said purchase for generating a purchase order for said products and services;

code responsive to said purchase order for splitting said purchase order into a plurality of supplier orders whereby each supplier order contains products or services pertaining to a different supplier; and

code responsive to said each supplier order for notifying each supplier of the buyer's order in relation to the products or services pertaining to that supplier.

The program may also include code responsive to confirmation of delivery of said product(s)/services(s) or the passing of a predetermined time period for generating said invoice in respect of each one of the supplier orders and for facilitating payment of each supplier between a funding organisation associated with or independent from the broker. The program may include code responsive to queries by one or more of said supplier, buyer or funder for providing status information pertaining to said purchase order.

According to the present invention, there is further provided an apparatus for facilitating transactions between a prospective purchaser and a plurality of unrelated product or service suppliers, the apparatus comprising:

a product/service database for storing product and/or service information for said plurality of suppliers;

a supplier database for storing supplier contact information;

a buyer's database for storing buyer contact information;

a product or service selection database into which product(s) or service(s) selected by the buyer are stored;

a processor for generating a purchase order pertaining to said selected products or services in response to a command from a purchaser, and for splitting said purchase order into separate orders of products or services pertaining to respective suppliers; and

a communication interface for transmitting respective purchase orders to respective suppliers.

The buyer's contact database may include registration and historical purchase data. An administration facility may be provided for facilitating access to a product order record and a product order status by one or more of a buyer, supplier and funder.

According to the present invention, there is further provided an apparatus for facilitating transactions between a prospective purchaser and a plurality of unrelated product or service suppliers, the apparatus comprising:

a store for product and/or service information for said plurality of suppliers, supplier and buyer contact information, and a buyer product/service selection;

processor means for generating a purchase order pertaining to said selected products or services in response to a command from a purchaser, and for splitting said purchase order into separate orders of products or services pertaining to respective suppliers; and

communication means for transmitting respective purchase orders to respective suppliers.

The communication means is operative for receiving product/service, supplier information, buyer data, product selection and funder data and storing same in respective databases.

The processor means is operative for tracking the progress of an order and maintaining product status flags in an order status database. The status of an order may be indicated as: funder acceptance of order pending; funder confirmation of order; funder refusal of order; supplier decline of order; supplier dispatch; and supplier query. The processor means, communication interface and order status database may co-operate to provide an administration means accessible by any one of the buyer, supplier(s) or funding organisation for the purpose of tracking the progress of the order.

According to the present invention, there is still further provided a programmed computer operated by a buyer to establish from a remote location ordering of products or services from a plurality of suppliers by way of a single purchase order, said computer comprising:

a communication interface for establishing communication with a remote product/service buyer and a funding organisation;

a memory storing product, supplier, buyer information, information about said funding organisation and a computer program; and

a processor for executing said computer program;

wherein said computer program includes:

code responsive to a command from the buyer to proceed with said purchase for generating a purchase order for products and services selected by said buyer;

code responsive to said purchase order for splitting said purchase order into a plurality of supplier orders whereby each supplier order contains products or services pertaining to a different supplier; and

code responsive to said each supplier order for notifying each supplier of the buyer's order in relation to the products or services pertaining to that supplier.

Embodiments of the present invention advantageously facilitate trade between a single buyer and plurality or multiplicity of suppliers through the intermediary of a broker in a business to business environment. The creation of a single purchase order by a buyer for the supply of products or services from more than one different entity supplier, and the automatic splitting up or distribution of the purchase order to respective suppliers simplifies the transactional process for the buyer. Moreover, the facility to generate separate invoices for the buyer in respect of each supplier means that the buyer is able to account for the transactions. The provision of bank-to-bank or electronic fund transfer makes the system particularly suitable for business to business transactions especially when it is considered that credit card payment is not normally acceptable in the business to business environment.

The invention will now be described by way of example with reference to the accompanying drawings in which:

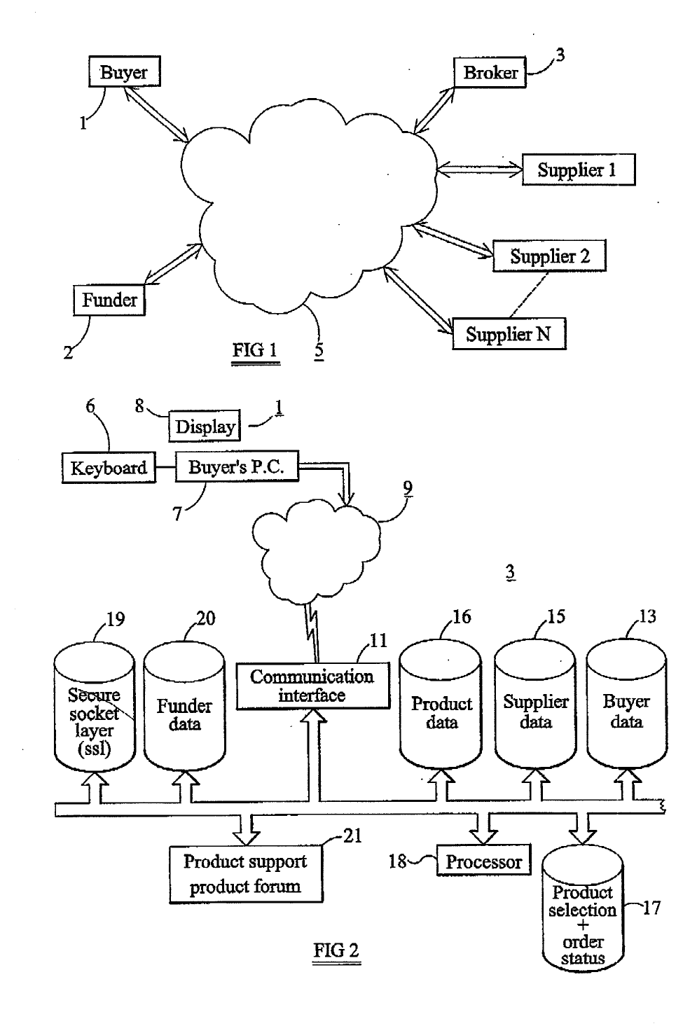

FIG. 1 is a schematic diagram illustrating the relationship between the participants of a trading system embodying the present invention;

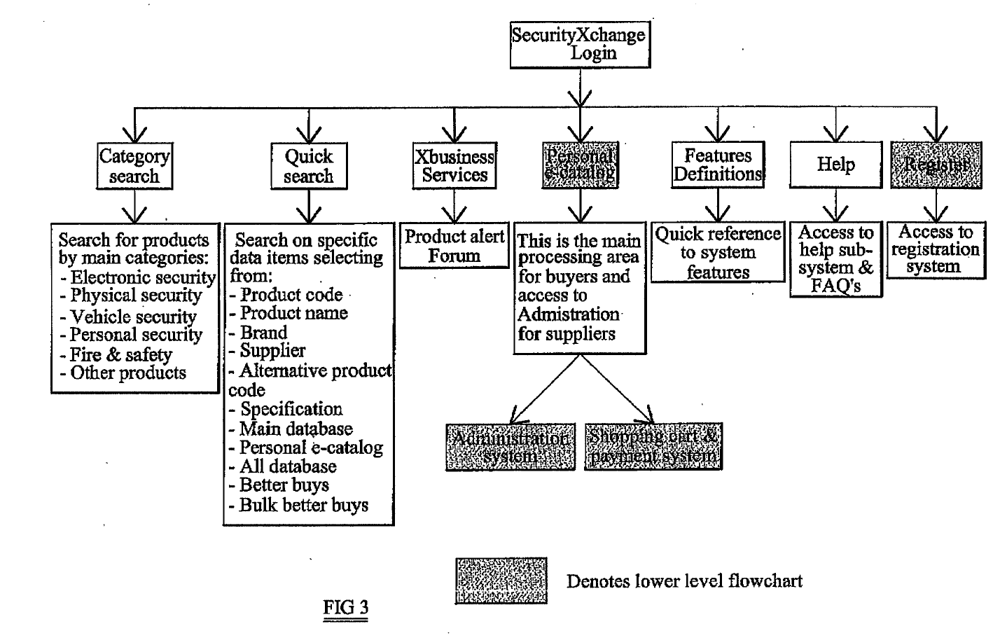

FIG. 2 is a schematic block diagram showing components of a broker's computer apparatus implemented in accordance with the present invention;

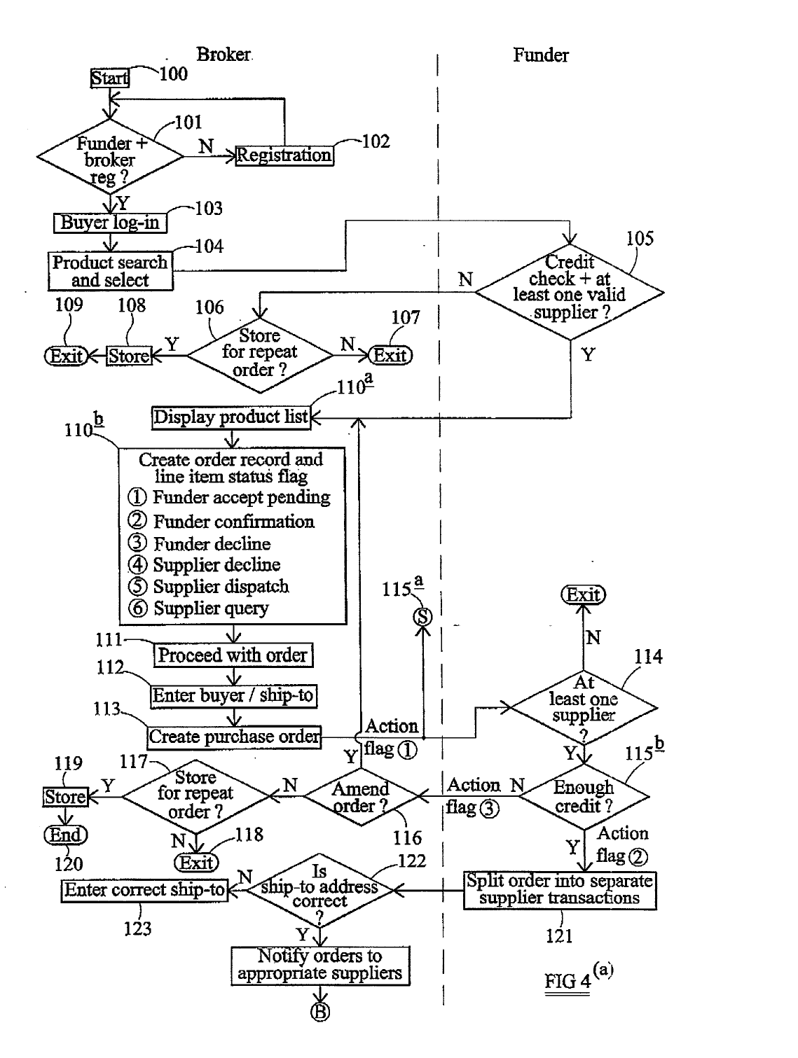

FIG. 3 is a schematic block diagram showing the functions available on a ‘home page’ of an embodiment of the present invention;

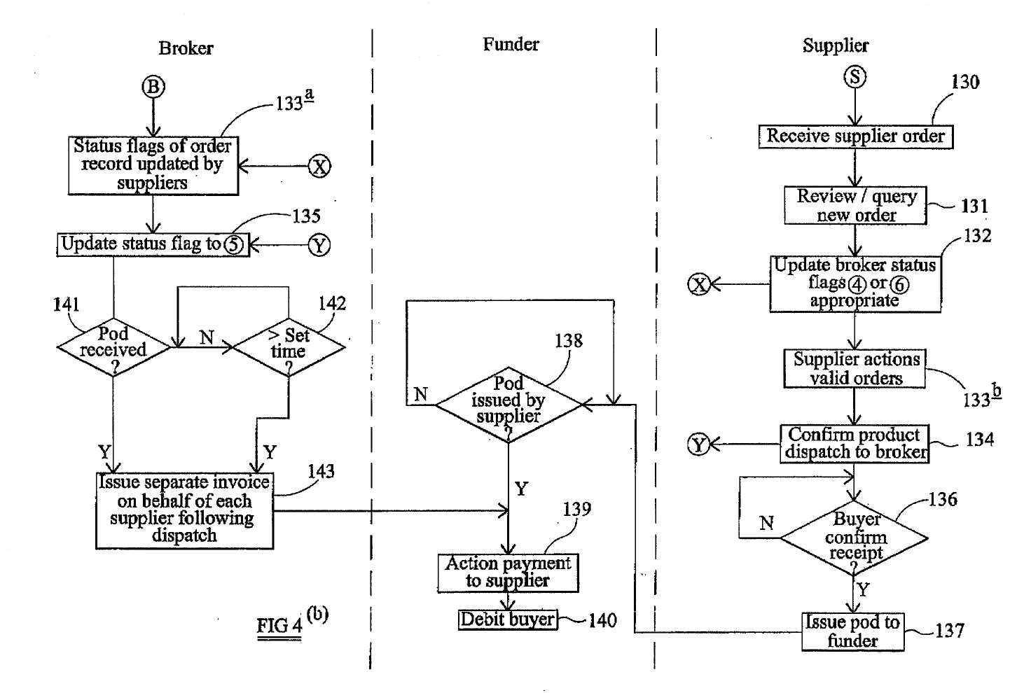

FIGS. 4a and 4b show a flow chart of the procedural steps taken when implementing embodiments of the present invention; and

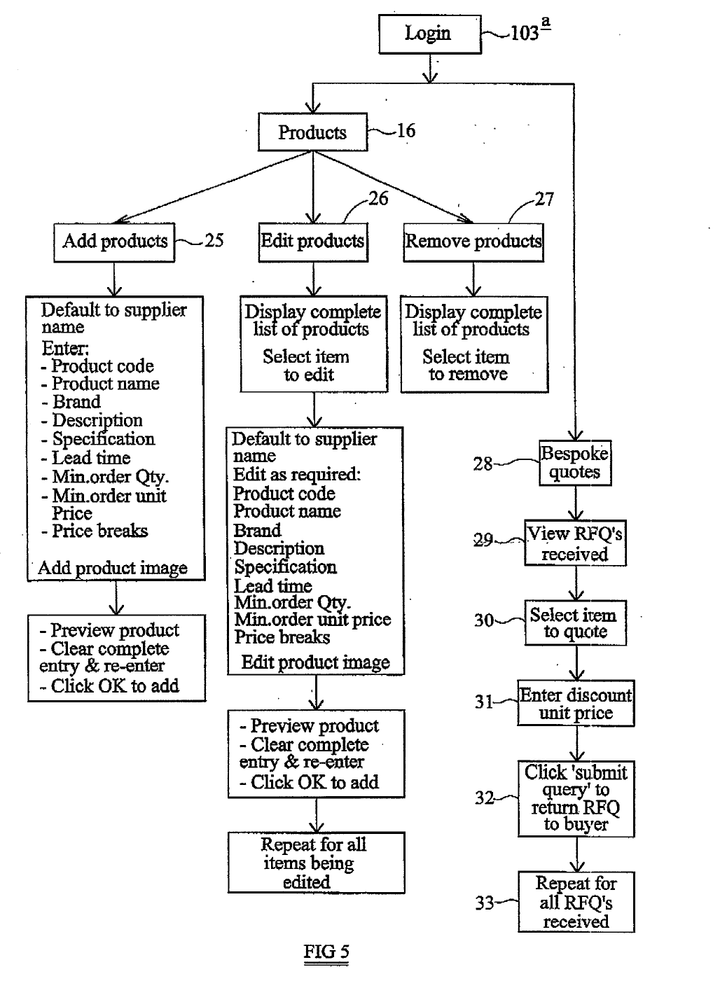

FIG. 5 is a schematic block diagram of an administrative function which may be incorporated into embodiments of the present invention.

Embodiments of the present invention facilitate trading of goods and services between an individual buyer and a plurality of disparate service or product suppliers (i.e. ones which might be independent of one another). The relationship between the parties involved in implementation of embodiments of the invention is illustrated in FIG. 1 which shows a buyer 1, a funding organisation 2, a broker 3 and a plurality of suppliers 1, 2 . . . N. These parties can communicate with each other by an Intranet or Internet based system denoted generally by reference numeral 5. The buyer 1 may be a private individual or business entity and the funding organisation may be a bank. The suppliers may be service or product providers. The broker 3 facilitates trade in accordance with the present invention in a manner which will be described in more detail below with reference to FIGS. 2, 3, 4a and 4b, and 5 below.

In the prior art, the buyer may access via, for example an Internet web-site, one or more suppliers. In the event that the buyer 1 wishes to purchase a product or service offered by a supplier, it is necessary for the buyer 1 to gain access to each supplier's web-site separately or to make direct contact with them by conventional means (i.e. direct personal contact or by telephone). Although it is known in the art for the buyer 1 to be able to make a purchase directly via the web-site of a supplier 1, 2 . . . N, payment is effected by the buyer 1 providing his credit card details to the supplier 1, 2 . . . N by telephone or by sending a cheque in the mail. Some web-sites provide for the entry of credit card details. However, the buyer 1 is only able to purchase and pay for more than one product or service from a single supplier when accessing a single supplier web-site. That is he cannot purchase from a plurality of suppliers. Business-to-business transactions do not generally adopt credit card payment methods.

In embodiments of the present invention, a buyer can access via the broker's web site product information for more than one supplier. The broker 3 is set up to act as an intermediary between the buyer and each one of the product or service suppliers registered with it. The broker 3 also acts as an intermediary between the funding organisation 2, the buyer and suppliers.

FIG. 2 illustrates the configuration 3 of the broker's server which is accessible via an Intranet or Internet based system. The buyer's computer apparatus (designated generally in FIG. 2 by reference numeral 1) consists of the usual personal computer components, namely a keyboard 6, processor 7 and display 8. A buyer 1 wishing to access the web-site of the broker 3 enters the broker's web-site via, for example, the Internet, shown generally in FIG. 2 by reference numeral 9. A communication link, by way of modems, is established between the buyer 1 and the broker 3 via communication interface 11. The broker's server 3 comprises a number of databases including: a buyer database 13 comprising contact information and product history for each buyer registered with the broker's service; a supplier database 15 for storing the contact and product information of suppliers registered with the broker; a product/service database 16; a product selection and order record/status database 17 for storing buyer product selections and for storing the order status whereby the progress of an order can be monitored; and a funder database 20 for storing information relating to the funding organisation. The broker's server additionally includes: a processor 18 for processing data and running operational programs for implementing the functions of the broker; a secure socket layer (SSL) 19 which provides for secure electronically encrypted communications between the parties; and a product support and product forum facility 21.

In operation, the buyer 1 establishes a selection of the products and/or services to be purchased by selecting these from a list provided on the broker's web-site. This can be done by checking items in drop-down menus provided on the broker's site. Once the buyer 1 has compiled a list of products and services to be purchased, the broker 3 checks whether the buyer 1 and the relevant suppliers satisfy credit status criteria with the funding organisation 2. If the credit and status request is validated by the funding organisation 2, the broker 3 splits the purchase order made by the buyer 1 into separate supplier transactions and sends these to each supplier. When the suppliers despatch the products or perform the services for the buyer 1, the suppliers notify the broker 3 by way of a “Proof of Delivery” (POD) notice. Receipt of the POD by the funderer leads to payment of the suppliers by the funding organisation 2 and the generation of separate invoices for each of the suppliers by the broker 3 for despatch to the buyer 1.

FIG. 3 shows which functions are available to the buyer entering the ‘home page’ of the broker. Reference will be made to these when explaining the process steps illustrated in the flow chart of FIGS. 4a and 4b.

In FIG. 4a, a buyer 1 wishing to make a purchase of products and services accesses the broker's web-site at step 100. Once the buyer 1 has entered the broker 3's web-site, he is presented with an HTML ‘home-page’ of the broker's trading exchange web-site. This web-page may provide the buyer 1 with a number of options including an option to select a product category from a drop-down list (see “Category Search” and “Quick Search” in FIG. 3) and an opportunity to register (see “Register” in FIG. 3) himself with the broker 3 in the event that this has not been done already. The buyer 1 may click on a “Registration” button (not shown) which links into a registration system generated by the broker 3's server which can then be completed and submitted buy the buyer 1. The Quick Search option enables the buyer to conduct a keyword search for a desired product under product name, brand or supplier. This option may also provide for searches on product code, user definable product code, and a string of characters within the product specification.

The broker's home page may include links to other pages of the broker's web-site, including a shopping basket comprising a facility to permit the buyer to add contents to a list indicating the product and supplier name, quantity, delivery lead time and cost. There may be provision for removing or modifying selected items in a manner known in the art. A “Repeat Order” facility may be provided whereby the buyer 1 may assign a name to a particular group of product items likely to be ordered on a repeat basis. The broker's home page may also include a facility for providing customer feedback (see “Help”, “Features Definitions” and “Xbusiness Services” in FIG. 3). For example, a form may be generated by the broker's web-site by providing for entry of a recommended supplier by the buyer and other comments on the trading exchange.

In a preferred arrangement, the broker 3 may provide a web-page link for “Bespoke Quotes”. When the buyer 1 clicks a “Bespoke Quotes” button, an opportunity to obtain special discounts from one or more of the suppliers from the buyer's list may be requested. When the buyer 1 clicks on the proceed button, details of the quotes request are despatched to each supplier for them to consider in each individual case.

Before a prospective buyer can access the broker's product ordering system, a user identification (user ID) and password must be entered to ensure security. At step 101 of FIG. 4a, the broker 3 determines whether the buyer is registered with the broker and the associated funding organisation. If not, the opportunity of registering his details is provided at step 102. Here, the buyer may click a button to register as a user of the trading exchange. Clicking of the registration button at step 102 runs a registration program at the broker's server to generate relevant forms for transmittal to the buyer's personal computer. On arrival and display at the buyer's personal computer, the relevant personal and/or company information is entered by the buyer for transmittal back to the broker's server. When the completed registration form is received by the broker's server, the information contained therein is captured and stored in a buyer database 13 (see FIG. 2). Registration information supplied by the buyer is also transmitted to the funding organisation or bank which may be a separate entity from the broker. Registration of a buyer may or may not be accepted by the broker and bank depending on whether the prospective purchaser satisfies certain credit and status criteria. Similarly, product or service suppliers may register with the broker and bank. Successful registration is subject to whether or not predetermined creditworthiness and status criteria are met. The objective is to ensure that participants in the trading exchange are reliable so that products or services ordered by the buyer are properly delivered by the suppliers and paid for in a timely manner (by the buyer). As will be described below, the broker acts as an intermediary who enables the placement of orders with multiple suppliers from a single buyer and facilitates the payment to the suppliers by an independent funding organisation or bank which in turn debits the relevant funds from the buyer and credits an appropriate commission through the broker. In legal terms, the contract is likely to be between the buyer and the respective suppliers, the broker merely acting as a trade facilitator.

A buyer who is registered with the trading exchange can log in at step 103 by entering his user ID and password. At step 104 the buyer can search or select for products as described above whereupon the broker will conduct a credit check against the buyer. The broker will also check the status of each supplier to ensure that even if a supplier is registered with the broker, the buyer selected suppliers are still in good standing. The broker 3 communicates with the funding organisation or bank remotely. This may be done by way of a telecommunication link or a person-to-person contact. This is preferably carried out by direct electronic communication via an Intranet or Internet system. On receipt of the credit check and supplier validation request from the broker 3, the funder 2 conducts an appropriate check at step 105. In the event that the bank determines that the buyer does not satisfy the credit criteria or none of the chosen suppliers has a currently valid status, a negative response is transmitted back to the broker whereupon the buyer is given the opportunity to store his order selection for resubmission at a later date at step 106. If the buyer does not avail himself of the option to store the repeat order at step 106, he may exit the system at 107. Alternatively, he may store the order at step 108 and then exit the system at step 109.

At step 104, the buyer may select the products to be ordered by retrieving these from his own dedicated catalogue which may be stored in the buyer database 13 of the broker. Alternatively, he may access the product/service supplier information from the broker's database 16 (see FIGS. 2 and 3). Performance of the credit and validation step 105 may be initiated when the buyer clicks his shopping basket to view the product/service contents. This causes the broker to contact the funder to perform the appropriate credit and supplier validation check. Also when the buyer clicks his shopping basket to view the contents, the broker may determine the monetary value of the proposed service/product order and conduct a check on availability. Any unavailable products may be highlighted in red. The display of the product list at step 110a is followed by implementation of an order tracking system which tracks the progress of the order and provides the means for informing the buyer and supplier of the status of the order.

An order record is created at step 110b. The data of the order record is stored in an order status database 17 at the broker's server. Against each product or service item is a status flag which indicates whether the finder organisation 2 has accepted that the order is pending, confirmed or declined. Additionally, the status flag may indicate whether the supplier has declined, despatched or queried the order. The order record status flag is updated by the order requesters as will be described below in more detail.

If the buyer wishes to proceed with the order displayed in the product list, notwithstanding any unavailable orders highlighted in red, he may proceed with the order by clicking an appropriate button at step 111. The broker's exchange prompts the buyer at step 112 to enter his shipping address. Following the entry of the shipping address, a processing device illustrated by reference numeral 18 in FIG. 2 generates a purchase order at step 113 and seeks reconfirmation from the finder as to whether or not at least one supplier within the product list is valid. The funder conducts this validation step at step 114 and if negative the order is terminated and the buyer notified accordingly. On creation of the purchase order and transmission of the validation request to the funder for validation at step 114, the line item status flag is actioned to indicate that funder acceptance is pending. As well as requesting reconfirmation from the funder at step 114, the processor 18 splits the purchase order into separate orders for each supplier and transmits these to each supplier as indicated at “S” at step 115a. Respective purchase orders are received by respective suppliers as indicated at step 130 of FIG. 4b. The orders are reviewed, processed and queried as required at step 131. If any supplier has a query in relation to an order, this is transmitted to the broker so that the query can be read by the buyer accessing the order status record of the broker's web-site. For example, the query may be suggesting an alternative product or one at a different price. Meanwhile, the funding organisation or bank performs a check as to whether the total monetary value of the order exceeds the buyer's credit limit at step 115b. If there is insufficient credit for the requested order, an appropriate signal is transmitted back to the broker whereupon the line item status flags are updated to indicate a funder decline. The broker provides the buyer with an opportunity to amend the order at step 116 in case the buyer wishes to bring his order to within his credit limit by deleting or amending the order. As an alternative to amending the order at step 116, the buyer may store the order for transmission at a later date at step 117. If declined, the buyer exits the system at 118. If accepted, the order is stored at step 119 and then the buyer exists the system at step 120. In the event that there is sufficient credit with the bank for the full order to proceed, an appropriate signal to this effect is transmitted back to the broker, whereupon the line item status flags are amended to indicate funder confirmation. The funder then splits the order into separate supplier transactions at step 121 and writes these into its database so that the suppliers can be paid by the funder. At step 122, the broker asks the buyer to confirm the correct shipping address and provides the buyer with an option to enter the correct address at step 123 if it is not correct and then confirms to each supplier that it is in order to proceed with despatch of the product at step 124.

The suppliers update the broker of the status of the orders at step 132, the line item status flags being updated to indicate whether the supplier declines or queries the order at step 133a. In the event that the supplier(s) accepts rather than declines or queries the order, the valid orders are despatched to the buyer and this is confirmed at steps 133b and 134. Confirmation of the despatch of the product to the broker at step 134 leads to updating of the status flag to indicate despatch at step 135.

Once the supplier(s) has despatched the product, he waits to receive confirmation of receipt from the buyer via the broker's web-site at step 136. If the supplier identifies that receipt has been confirmed, a “Proof of Delivery” statement (POD) is issued to the funder at step 137. After the funder has written the orders into its database at step 121, it awaits issuance of the POD by the supplier at step 138. Once received, the funder actions payments to each supplier at step 139 and issues a payment in relation to the broker's commission. The funder then debits the buyer's account at step 140.

The broker issues invoices to the buyer once the issuance of a POD has been received by the broker at step 141. If no POD is received within a predetermined period of time, for example seven days, the broker notifies the funder that the product or services have been received by default and automatically sets in train the generation of invoices at step 142 and 143. Separate invoices are issued on behalf of each supplier for the buyer's accounting system.

For buyers and suppliers registered with the broker, an administration system is provided to facilitate viewing of the order status record, product lists are viewed by the buyer so that each party can monitor the progress of the order. FIG. 5 is a schematic illustration of the administration system. Once the buyer has logged in at step 103a, he may review the products stored on the broker's database 16 and add, edit or remove products from his list as illustrated at 25, 26 and 27 in FIG. 5. Alternatively, the buyer may seek his bespoke quotes as indicated above. The broker's administration pages may be configured to guide the buyer through the protocol for seeking bespoke quotes from suppliers as illustrated in steps 28 to 33 of FIG. 5.

Communications between the broker, buyer, supplier and funder may be encrypted by a one of a several methods known in the art. The broker's server is provided with a secure socket layer 19 (SSL) for this purpose.

The funding organisation or bank provides for the making of secure payments on-line. The payments may be effected by a secure on-line business trading system such as “speedyduck” (Trade Mark) which is accessible at the URL: http://www.speedyduck.com. An example of the broker's web pages may be seen at: http://www.securityxchange.co.uk/.

1. A method of facilitating trade between a prospective buyer and a plurality of product or service suppliers comprising the steps of:
providing a prospective buyer with an option to select products or services for purchase from a plurality of different product and/or service suppliers;
generating a purchase order for said products and services in response to a command from the buyer to proceed with said purchase;
splitting said purchase order into a plurality of supplier orders whereby each supplier order contains products or services pertaining to a different supplier; and
notifying each supplier of the buyer's order in relation to the products or services pertaining to that supplier.

2. The method according to claim 1, including the step of holding the selection in a virtual shopping cart or basket and wherein the step of notifying includes providing to each supplier the prospective buyer's shipping address.

3. The method according to claim 1, including the step of generating an invoice in respect of each one of the supplier orders.

4. The method according to claim 3 performed by an intermediary organisation, said intermediary carrying out the steps of transmitting said invoice to the buyer.

5. The method according to claim 1, comprising the step of notifying a funding organisation of funds to be paid to each supplier for the services or products pertaining to that supplier, whereby said funding organisation is able to transfer said funds to said supplier and debit said funds from a buyer.

6. A computer executable software program stored on a computer readable medium which when run on a central computer provides a prospective buyer with an option to select products or services for purchase from a plurality of different product and/or service suppliers, said program comprising:
code responsive to a command from the buyer to proceed with said purchase for generating a purchase order for said products and services;
code responsive to said purchase order for splitting said purchase order into a plurality of supplier orders whereby each supplier order contains products or services pertaining to a different supplier; and
code responsive to said each supplier order for notifying each supplier of the buyer's order in relation to the products or services pertaining to that supplier.

7. A computer executable software program according to claim 6, including code responsive to confirmation of delivery of said product(s)/services(s) or the passing of a predetermined time period for generating an invoice in respect of each one of the supplier orders and for facilitating payment of each supplier by a funding organisation.

8. A computer executable software program according to claim 7, wherein the program includes code responsive to queries by one or more of said supplier, buyer or funding organisation for providing status information pertaining to said purchase order.

9. An apparatus for facilitating transactions between a prospective purchaser and a plurality of unrelated product or service suppliers, the apparatus comprising:
a product/service database for storing product and/or service information for said plurality of suppliers;
a supplier database for storing supplier contact information;
a buyer's database for storing buyer contact information;
a product or service selection database into which product(s) or service(s) selected by the buyer are stored;
a processor for generating a purchase order pertaining to said selected products or services in response to a command from a purchaser, and for splitting said purchase order into separate orders of products or services pertaining to respective suppliers; and
a communication interface for transmitting respective purchase orders to respective suppliers.

10. An apparatus for facilitating transactions according to claim 9, wherein the buyer's contact database includes registration and historical purchase data.

11. An apparatus for facilitating transactions according to claim 9 comprising an administration facility for facilitating access to a product order record and a product order status by one or more of a buyer, supplier and funding organisation.

12. An apparatus for facilitating transactions between a prospective purchaser and a plurality of unrelated product or service suppliers, the apparatus comprising:
a store for product and/or service information for said plurality of suppliers, supplier and buyer contact information, and a buyer product/service selection;
processor means for generating a purchase order pertaining to said selected products or services in response to a command from a purchaser, and for splitting said purchase order into separate orders of products or services pertaining to respective suppliers; and
communication means for transmitting respective purchase orders to respective suppliers.

13. An apparatus for facilitating transactions according to claim 12, wherein the communication means is operative for receiving product/service, supplier information, buyer data, product selection and funding organisation data and storing same in respective databases.

14. An apparatus for facilitating transactions according to claim 12, wherein said processor means is operative for tracking the progress of an order and maintaining product status flags in an order status database.

15. An apparatus for facilitating transactions according to claim 14, wherein the status of an order is indicated as one or more of: funding organisation acceptance of order pending; funding organisation confirmation of order; funding organisation refusal of order; supplier decline of order; supplier dispatch; and supplier query.

16. An apparatus for facilitating transactions according to claim 14, wherein the processor means, communication interface and order status database co-operate to provide an administrator accessible by any one of the buyer, supplier(s) or funding organisation for the purpose of tracking the progress of the order.

17. A programmed computer operated by a buyer to establish from a remote location ordering of products or services from a plurality of suppliers by way of a single purchase order, said computer comprising:
a communication interface for establishing communication with a remote product/service buyer and a funding organisation;
a memory storing product, supplier, buyer information, information about said funding organisation and a computer program; and
a processor for executing said computer program;
wherein said computer program includes:
code responsive to a command from the buyer to proceed with said purchase for generating a purchase order for products and services selected by said buyer;
code responsive to said purchase order for splitting said purchase order into a plurality of supplier orders whereby each supplier order contains products or services pertaining to a different supplier; and
code responsive to said each supplier order for notifying each supplier of the buyer's order in relation to the products or services pertaining to that supplier.

18. In a method of facilitating trade between a prospective buyer and a plurality of product or service suppliers, the method comprising the steps of: providing a prospective buyer with an option to select products or services for purchase from a plurality of different product and/or service suppliers; generating a purchase order for said products and services in response to a command from the buyer to proceed with said purchase; splitting said purchase order into a plurality of supplier orders whereby each supplier order contains products or services pertaining to a different supplier; notifying each supplier of the buyer's order in relation to the products or services pertaining to that supplier; and notifying a funding organisation of funds to be paid to each supplier for the services or products pertaining to that supplier; the steps of:
receiving a supplier order in respect of products or services pertaining to a single supplier entity; wherein said supplier order has been derived from a single purchase order representing products or services requested by said buyer from a plurality of product or service supplier entities; and
receiving payment from said funding organisation in respect of said services or products pursuant to said supplier order.

19. A method of supplying from a single supplier entity a product or service to a buyer, the method comprising the steps of:
receiving at said single supplier entity via an Internet link a supplier order in respect of a product or a service pertaining to said single supplier entity, wherein said supplier order has been derived at a remote location from a single purchase order representing a plurality of products or services requested by said buyer from a plurality of different product or service supplier entities;
dispatching said product pertaining to said single supplier entity or performing said service pertaining to said single supplier entity to said buyer; and
receiving payment from a funding organisation in respect of said services or products pursuant to said supplier order in response to a payment authorisation received via said Internet link by said funding organisation from said remote location.
